(19) United States
(12) Patent Application Publication
(10) Pub. No.: US 2022/0363274 A1
(43) Pub. Date: Nov. 17, 2022

(54) TERTIARY CONTROL SYSTEM FOR STEERING, BRAKING, AND MOTION CONTROL SYSTEMS IN AUTONOMOUS VEHICLES

(71) Applicants: Steering Solutions IP Holding Corporation, Auburn Hills, MI (US); Continental Automotive Systems, Inc., Auburn Hills, MI (US)

(72) Inventors: Brian McGregor, Burch Run, MI (US); Chris Sommer, Swartz Creek, MI (US); Ulrich Auerswald, Clarkston, MI (US); Scott Millsap, Grand Blanc, MI (US); Patrick Steele, Saginaw, MI (US); Iulian Ungureanu, Oakland Twp, MI (US); Joachim Gerold, Grand Blanc, MI (US); Varunraj Shedge, Auburn Hills, MI (US)

(21) Appl. No.: 17/320,673

(22) Filed: May 14, 2021

(51) Int. Cl. B60W 50/023; B60W 50/035; B60W 50/04; B60W 60/00; B60W 10/18; B60W 10/20

(52) U.S. Cl. CPC B60W 50/023; B60W 50/035; B60W 50/04; B60W 60/0018; B60W 10/18; B60W 10/20; B60W 2756/10

(57) ABSTRACT

A number of illustrative variations may include a method or product for monitoring and responding to component, system, or module failure in an autonomous driving system.

### TECHNICAL FIELD

The field to which the disclosure generally relates to includes autonomous driving systems.

### BACKGROUND

Vehicles typically include a number of systems or modules for driving including but not limited to systems or modules for acceleration of the vehicle, deceleration of the vehicle, and steering of the vehicle.

### SUMMARY OF ILLUSTRATIVE VARIATIONS

A number of illustrative variations may include a method or product for monitoring and responding to component, system, or module failures in an autonomous driving system.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is an illustration of an autonomous vehicle control system according to a number of variations.

FIG. 2 is an illustration of a primary vehicle control system and select functions thereof according to a number of variations.

FIG. 3 is an illustration of a redundant vehicle control system and select functions thereof according to a number of variations.

FIG. 4 is an illustration of a tertiary vehicle control system and select functions thereof according to a number of variations.

FIG. 5A is a first section of three sections of a schematic illustration of a tertiary control system and additional components and systems cooperating therewith.

FIG. 5B is a second section of three sections of a schematic illustration of a tertiary control system and additional components and systems cooperating therewith.

FIG. 5C is a third section of three sections of a schematic illustration of a tertiary control system and additional components and systems cooperating therewith.

FIG. 6A is a first section of three section of a schematic illustration of a motion control system showing main and fallback paths, and additional components and systems cooperating therewith.

FIG. 6B is a second section of three section of a schematic illustration of a motion control system and additional components and systems cooperating therewith including an autonomous driving coordination module.

FIG. 6C is a third section of three section of a schematic illustration of a motion control system and additional components and systems cooperating therewith including a powertrain engine control module and a tertiary control system.

### DETAILED DESCRIPTION OF ILLUSTRATIVE VARIATIONS

The following description of the variations is merely illustrative in nature and is in no way intended to limit the scope of the invention, its application, or uses.

As used herein “autonomous vehicle” means an completely autonomous vehicle or a semi-autonomous vehicle.

As used herein, “or” is to be interpreted to mean an inclusive “or” unless otherwise stated. As a nonlimiting example, if “a peanut butter or jelly sandwich” were to be described herein, “or” should be interpreted in an inclusive manner such that the phrase is interpreted to disclose inclusively a peanut butter sandwich, a jelly sandwich, and a peanut butter and jelly sandwich.

As used herein, “wheels” or “wheel,” even when modified by a descriptive adjective such as but not limited to in the recitation of “steerable roadwheels,” “steerable wheels,” “road wheels,” or “driven wheels,” may refer to a traditional road wheel and tire arrangement, but may also refer to any modification to the traditional road wheel and tire arrangement such as but not limited to rimless mag-lev tires, ball tires, or any other known means of automotive movement such as but not limited to treads, casters, rollers, propellers, or gas thrusters, liquid thrusters, or ion driven thrusters.

As used herein, “road,” even when modified by a descriptive adjective may refer to a traditional driving surface road such as but not limited to a concrete or asphalt road but may also refer to any driving surface or medium along which or through which a vehicle for cargo or passengers may travel such as but not limited to water, ice, snow, dirt, mud, air or other gases, or space in general.

As used herein, “path” generally refers to a determined route of travel for a vehicle. Additionally, as used herein, “trajectory” generally refers to a dynamic path for a vehicle that may be changed by the planner module based upon at least one aspect of the vehicle's travel environment such as but not limited to road surface conditions. Additionally, a vehicle's trajectory may also be based upon at least one determined vehicle component, system, or module capability. Changes to a vehicle's trajectory may include a vehicle's manner of travel to vehicle travel characteristics such as but not limited to the distance by which the vehicle trails any other vehicle while travelling, the speed of the vehicle, the braking strategies or driving style of the vehicle, the acceleration rate of the vehicle for any given situation, or the merging rate of the vehicle, based upon at least one aspect vehicle's travel environment or at least one determined vehicle component, system, or module capability.

As used herein, “minimum risk maneuver” generally refers to the safest maneuver determined by the Automated Driving System to achieve a minimal risk condition based on the environmental conditions, traffic situation, failures in the vehicle systems, and driver availability, and may be generalized by following:
1. Stop immediately in lane.
2. Pull over to the side of the road.
3. Continue driving to the next safest location to stop,

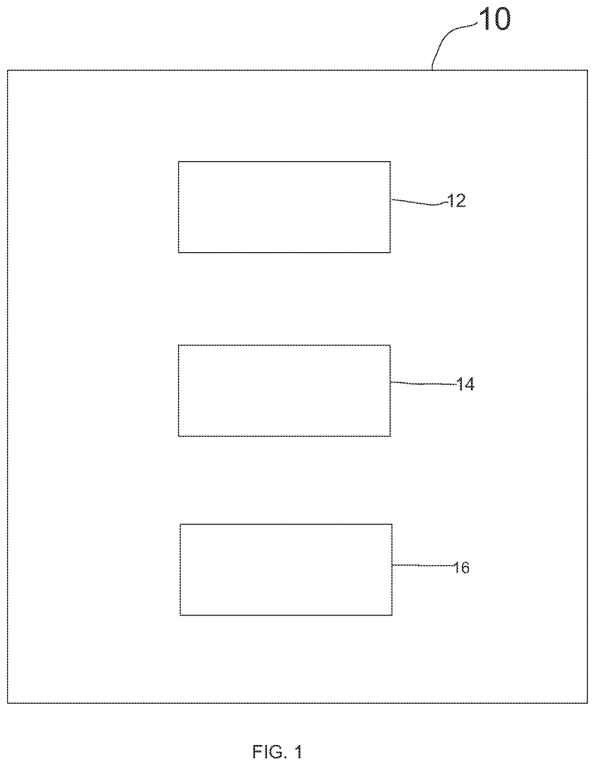

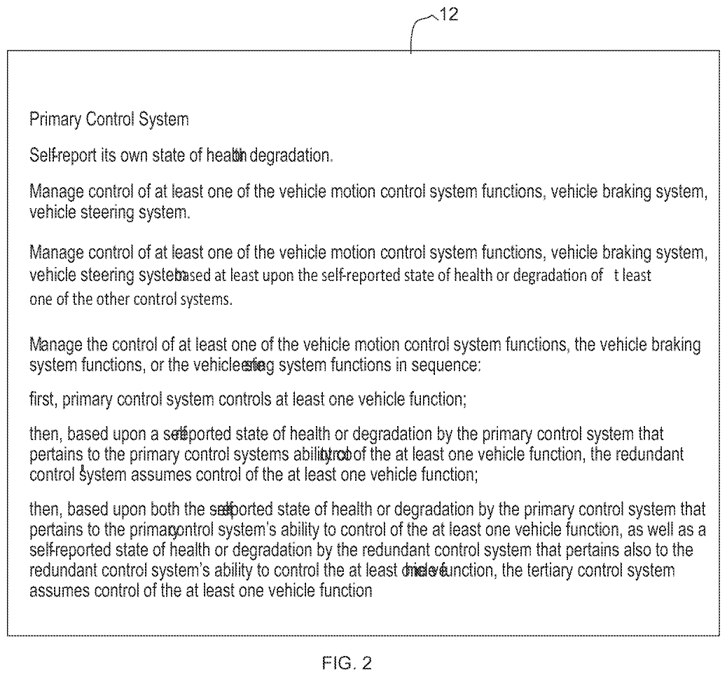

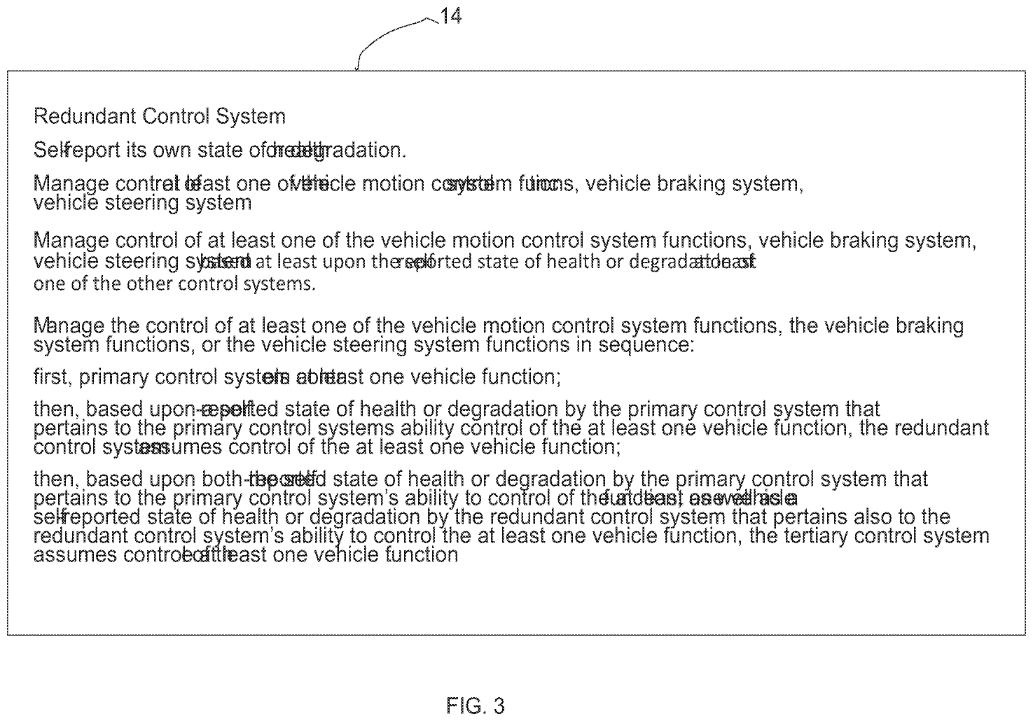

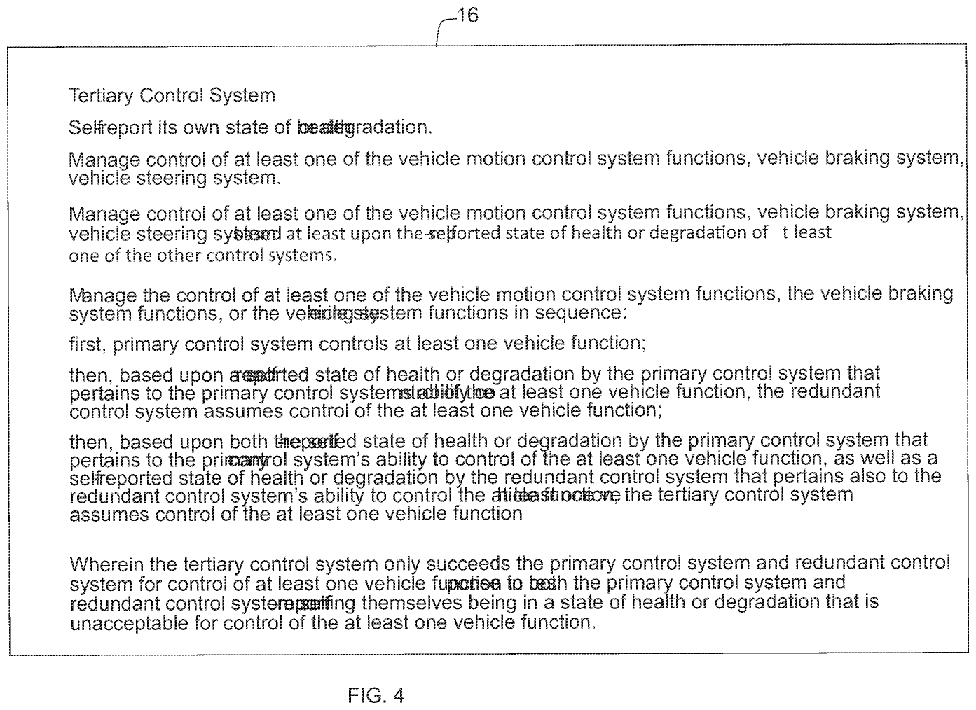

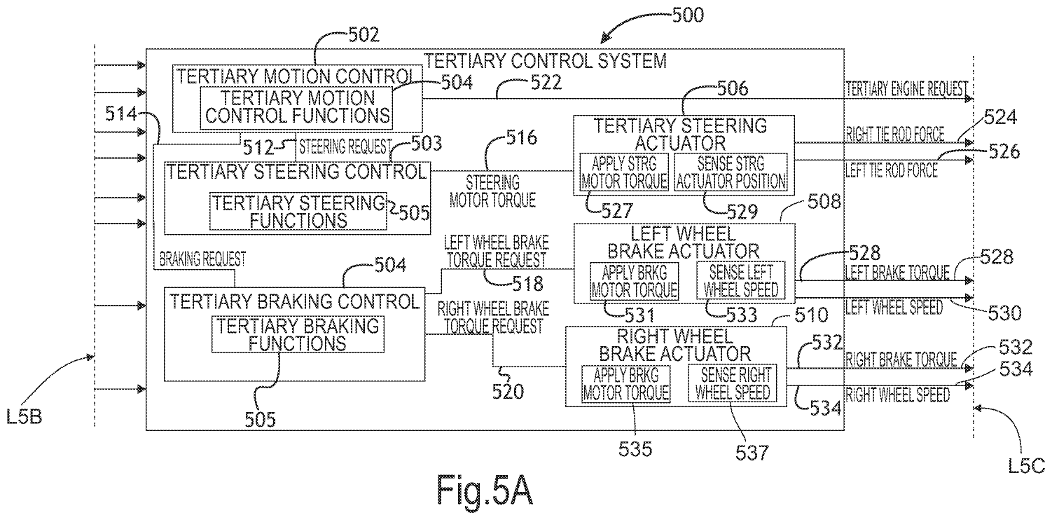

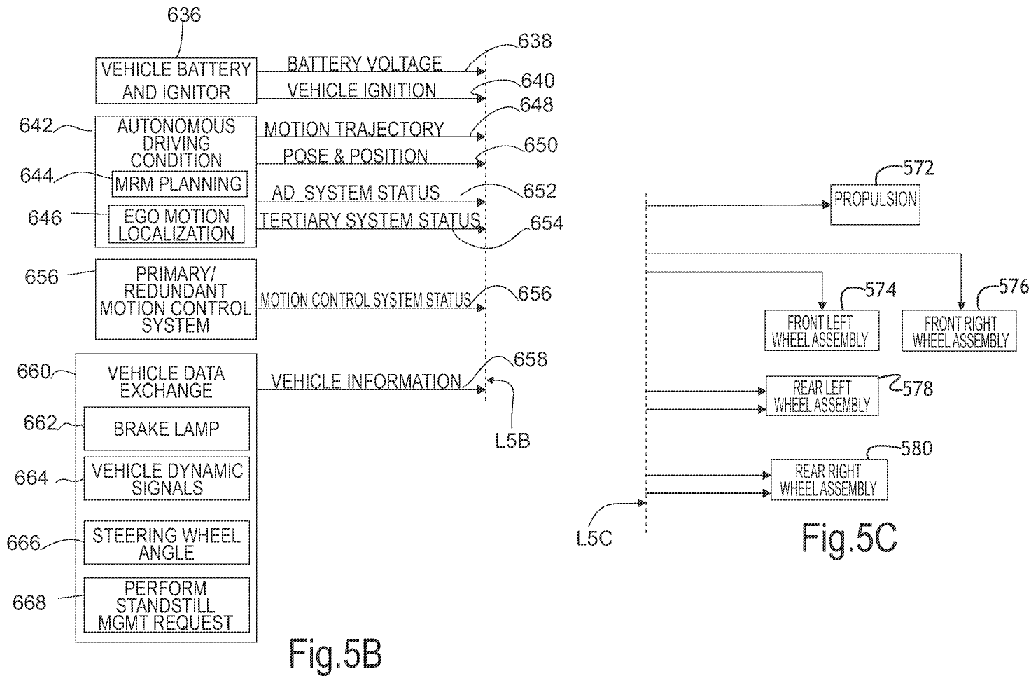

FIG. 1 is an illustration of an autonomous vehicle control system 10 according to a number of variations, which may include a primary control system 12, a redundant control system 14, and a tertiary control system. FIG. 2 is an illustration of a primary vehicle control system and select functions thereof according to a number of variations. FIG. 3 is an illustration of a redundant vehicle control system and select functions thereof according to a number of variations. FIG. 4 is an illustration of a tertiary vehicle control system and select functions thereof according to a number of variations. FIG. 5A is a first section of three sections of a schematic illustration of a tertiary control system and additional components and systems cooperating therewith. FIG. 5B is a second section of three sections of a schematic illustration of a tertiary control system and additional components and systems cooperating therewith. FIG. 5C is a third section of three sections of a schematic illustration of a tertiary control system and additional components and systems cooperating therewith.

In a number of illustrative variations, a number of vehicle components may be capable of self-diagnosing in that they are capable of reporting their own failure or performance capability to at least one control system or module such as but not limited to a primary control system or module, a redundant control system or module, or a tertiary control system or module. In some such cases, component failure may be determined by a control system or module correlating component capabilities to functional safety requirements. Such functional safety requirements may be arbitrarily set or may be set based upon an existing standard like law or industry standards and may be editable.

In a number of illustrative variations, a vehicle for cargo or passengers may be driven ahead by an automotive power derived from a motor that transforms a source of stored energy into a driving force for the vehicle such as but not limited to an internal combustion engine, a battery powered engine, a fuel-cell powered engine, or any other known motor for providing automotive driving power for a passenger or cargo vehicle. The driving force that results from the transformation of stored energy by or to the motor may be communicated from the motor to a driving medium along which the vehicle will travel such as but not limited to a tract of land, a road, a waterway, an airway, or any other medium along which vehicles are known to travel through space. The communication of the driving force from the motor to the driving medium may occur via any means of driven automotive vehicle movement such as but not limited to roadwheels, treads, casters, rollers, propellers, gas thrusters, liquid thrusters, or ion driven thrusters, or any other known means of driven automotive vehicle movement.

In a number of illustrative variations, a vehicle may have a steering system that allows a driver to change the vehicle's direction or divert it from a path that it may be traveling in. The vehicle's steering system may also be autonomous in that the vehicle may steer itself toward a predetermined location that has been communicated to it without assistance or interference from a driver. The vehicle may also include an obstacle avoidance system that allows the vehicle to sense objects in its path and avoid them.

In a number of illustrative variations, a vehicle may be equipped with a steering interface that may comprise a joystick, a trackball, a slider, a throttle, a pushbutton, a toggle switch, a lever, a touchscreen, a mouse, a handwheel, a rudder, pedals, a keyboard, or any other known means of user input.

In a number of illustrative variations, an autonomous driving system may be programmed with or be in communication with any number of logic modules arranged to autonomously address a number of areas of control within the realm of vehicle steering and travel including but not limited to vehicle acceleration, vehicle braking, autonomous path planning, performance capability monitoring and management, and an autonomous steering system for at least lateral control of the vehicle. The logic for the modules of the autonomous steering system may account for driver assistance or intervention in the steering or driving of the vehicle.

In a number of illustrative variations, an autonomous driving vehicle may be equipped with any number of sensors and monitoring systems for determining the state of health or degradation of any number of vehicle systems such as but not limited to drive systems, braking systems, electrical systems, exhaust systems, fuel systems, suspension systems, and any other vehicle systems, or individual vehicle components such as but not limited to actuators, gears, pumps, injectors, plugs, cylinders, wheels, tires, or steering interfaces by which a driver may steer the vehicle.

In a number of illustrative variations, the autonomous vehicle may comprise a motion control system or module that may collect or receive data from any vehicle system concerned with the motion of the vehicle such as but not limited to a braking system, a steering system, an engine control system, a fuel system, or electrical power generation and delivery system. In some such cases, the motion control system or module may be in direct or indirect communication with a path planner module. In some cases, a piece of electronic hardware such as but not limited to a processor, random access memory, a processor cache, a memory storage device such as but not limited to a hard drive or a solid-state drive may comprise the motion control system or module. An element of software such as but not limited to a routine, a thread, an operating system, a data structure, or a class may also comprise the motion control system or module. In some cases, the motion control system or module is a system to control the motion of an autonomous vehicle by acting on dynamically changing data such as but not limited to wheel speed data, road condition data, braking system or module data, driving system or module data, traffic data, lane data, fuel system data, motion control system or module data, weather data, passenger data such as but not limited to biometric data or perspective or gaze data. The motion control system or module may act on any data available to it in accordance with any number of algorithms regarding reasoned movement of the vehicle. The motion control system or module may act on the data available to it by affecting the motion of the vehicle via any means for doing so such as but not limited to manipulation of any of the driving systems or modules, the steering systems or modules, the braking systems or modules.

In a number of illustrative variations, an autonomous vehicle may comprise a braking system or module. In some cases, the braking system or module may be capable of inducing the vehicle to brake via the manipulation of at least one actuator, caliper, magnet, stator, transmission, or any other known means for decelerating or braking a vehicle. The braking system or module may be in communication with any other vehicle system or module such as but not limited to a drive system or module, a steering system or module, or a motion control system or module. The braking system or module may collect or receive data related to vehicle braking or vehicle deceleration including but not limited to road condition data, traffic data, gps data, steering system or module data, tire or road wheel condition data, vehicle speed data, vehicle acceleration data, road wheel speed data, road wheel orientation data, tire pressure data, tire friction coefficient data, driver biometric or perspective or gaze data, from any number of vehicle systems or modules, cameras, or sensors including but not limited to road cameras, cabin cameras, road wheel cameras, road wheel speed sensors, tire pressure sensors, heat sensors, a path planner system, brake actuator sensors, brake component degradation detection systems or modules, steering systems or modules, or motion control systems or modules.

In a number of illustrative variations, an autonomous vehicle may comprise a drive system or module. In some cases, the driving system or module may be capable of directing locomotive power to at least one vehicle road wheel via the manipulation of at least an engine of any sort, a motor, a drive shaft, a transmission, or any other known means for driving at least one vehicle road wheels forward. The drive system or module may be in communication with any other vehicle system or module such as but not limited to a braking system or module, a steering system or module, or a motion control system or module. The drive system or module may collect or receive data related to vehicle acceleration or vehicle locomotion including but not limited to road condition data, tire or road wheel condition data, vehicle speed data, traffic data, gps data, vehicle acceleration data, road wheel speed data, road wheel orientation data, brake system data, drive train performance data, fuel system data, engine performance data, tire pressure data, tire friction coefficient data, driver biometric or perspective or gaze data, from any number of vehicle systems, cameras, or sensors including but not limited to road cameras, cabin cameras, road wheel cameras, road wheel speed sensors, tire pressure sensors, drive train sensors, engine sensors, braking system sensors, or tire sensors.

In a number of illustrative variations, an autonomous vehicle may comprise a steering system or module. In some cases, the steering system or module may be capable of translating a manipulation of a steering interface such as but not limited to a handwheel to the movement of steering means such as but not limited to a steerable road wheel. The drive system or module may be in communication with any other vehicle system or module such as but not limited to a braking system or module, a drive system or module, or a motion control system or module. The steering system or module may collect or receive data related to vehicle turning capability or driving surface condition including but not limited to road condition data, tire or road wheel condition data, vehicle speed data, traffic data, gps data, vehicle acceleration data, road wheel speed data, road wheel orientation data, steering interface position data, data about any forces being applied to at least one steering interface, brake system data, drive train performance data, fuel system data, engine performance data, tire pressure data, tire friction coefficient data, driver biometric or perspective or gaze data, from any number of vehicle systems, cameras, or sensors including but not limited to road cameras, cabin cameras, road wheel cameras, road wheel speed sensors, tire pressure sensors, drive train sensors, engine sensors, braking system sensors, or tire sensors.

In a number of illustrative variations, an autonomous vehicle is self-driven in that it requires no human driver in order to steer itself to a predetermined destination. In such a case, a human driver may not be available to commandeer the steering, braking, or motion control system when one of those systems fails. In some such cases, redundant systems or modules or backup systems or modules may be used to ensure that the autonomous vehicle does not steer, drive, or brake in an uncontrolled manner by causing the autonomous vehicle to perform a minimum risk maneuver in order to ensure that the autonomous vehicle's passengers or cargo are brought to a relatively safe position on or near the road. In many cases, bringing the autonomous vehicle's passengers or cargo to a relatively safe position on or near the road entails performing at least one of a minimum risk steering maneuver or minimum risk braking maneuver to bring the vehicle and its contents or passengers to a stop at a position near the side of a road. In some such cases, this creates an issue of immobilization for the passengers or cargo and could potentially cause timing or scheduling problems for a logistics or taxi service. This sort of immobilization potentially spawns an additional task for another autonomous entity or human of retrieving or rescuing the immobilized cargo or passengers and in some circumstances the additional task of on-site repair of the immobilized autonomous vehicle. In some cases, an autonomous vehicle may comprise a back-up steering, braking, or motion control system or module that may allow the autonomous vehicle to continue on its journey in a reduced performance state rather than forcing the vehicle to perform a minimum risk maneuver to safely immobilize the autonomous vehicle. Such a back-up steering, braking, or motion control system or module is referred to as a redundant control system herein. In a case wherein the redundant steering, braking, or motion control system or module fails, the autonomous vehicle may utilize at least one of a tertiary steering, braking, or motion control system or module to aid the vehicle in performing a minimum risk maneuver to bring the autonomous vehicle to a safe position and state. In some such cases, after the tertiary control system or module induces the autonomous vehicle to perform a minimum risk maneuver, the tertiary control system or module may induce the autonomous vehicle to apply a parking brake so that the autonomous vehicle does not roll away.

In a number of illustrative variations, an autonomous vehicle may comprise a tertiary control module or system for any of the steering system, braking, or motion control systems or modules so that a failure of at least one of the steering, braking, or motion control systems or modules may be overcome or recovered from. In this way, the autonomous vehicle may avoid the need to end its journey with a minimum risk maneuver and in turn strand its occupants or cargo. In some such cases, the tertiary control system or module may be comprised of hardware or software diverse from the primary or redundant control systems. In some cases in which a physical piece of hardware such as but not limited to a processor comprises the primary or redundant control system or module, a separate physical piece of hardware such as but not limited to a processor may comprise the tertiary control system or module. That is, the separate physical piece of hardware may be functionally separate from the piece of hardware comprising the primary or redundant control system or module such that a failure in the piece of hardware comprising the primary or redundant control system or module does not necessarily constitute a failure in the separate piece of hardware comprising the tertiary control system or module. In some cases in which a piece of software such as but not limited to a routine, an operating system, or a thread comprises the primary or redundant control system or module, a separate piece of software such as but not limited to a routine, an operating system, or a thread may comprise the tertiary control system or module. In some such cases, the piece of software comprising the tertiary control system or module may be partitioned from the primary or redundant control system or module such that primary or redundant control system or module cannot affect key operating variables of the tertiary control system or module. That is, the partitioning of software may take place according to any number of known methods to ensure that, if the memory or operating variables of the primary or redundant control system or module are corrupted or defective, the defective control system or module is not able to negatively affect the piece of software comprising the tertiary control system or module. Such software and hardware separation or partitioning may also apply for any redundant control systems or modules.

In a number of variations, the tertiary control system or module may have operation modes, which may include any one or more of the following: 1. Active mode—Actively controlling braking and steering—wherein backup controller is active when there is a complete (dual point) failure in either redundant steering system or redundant brake system. 2. Monitoring mode—Not controlling steering or braking—Backup controller is in monitoring mode when there is a no failure in either redundant steering system or redundant brake system. However, backup controller shall send health status signal to ADS every ‘x’ seconds. 3. Standby mode—Not controlling steering or braking
Backup controller is in standby mode when there is a single point failure in either redundant steering system or redundant brake system. However, backup controller shall send health status signal to ADS every ‘x’ milliseconds. 4. Disable mode—Failures in backup controller—Backup controller is in disable mode when there is a failure in the backup controller itself. ADS shall periodically monitor the health status of backup controller. In a number of illustrative variations, a tertiary control system or module monitors state of health information pertaining to at least one of the steering, braking, and motion control systems or modules. In such illustrative variations, the monitored health information may indicate one or more points or areas of failure in the monitored systems or modules. In some cases, when at least one failure has occurred, but the performance of the control system or module in which at least one failure occurred is not significantly degraded, the tertiary control system or module switches into a monitoring mode to monitor the performance of the vehicle and monitor the relevant control systems for further, possibly related failures. In some cases, when at least one failure has occurred that has significantly degraded the performance of the control system or module in which at least one failure occurred, the tertiary control system or module switches into an active mode which may entail the tertiary control system or module stepping into the shoes of or taking over the vehicle systems that the failed control system or module controls and in some cases controlling redundant steering actuators or braking actuators.

In a number of illustrative variations, any vehicle component, system, or module may have at least one identifiable state of failure. As used herein, “state of failure” may refer to any vehicle component, system, or module failing to function in a satisfactory manner as determined by a tertiary control system or module. In some such cases the determination of failure to function may be based upon relevant safety standards or engineering performance goals such as but not limited to top-level requirements, first level requirements, second level requirements, and so forth. Additionally, “initial integrity” may refer to the to the state of health or degradation of any vehicle component, system, or module as measured from the time of its manufacture or installation, or may refer to the to the state of health or degradation of any vehicle component, system, or module as measured from the time that the vehicle is started up for the very first time. Generally, the “initial integrity” of a vehicle component, system, or module may refer to that component, system, or module's fitness for use according to at least one of its intended purposes as measured from a particular or “initial” point in time. The foregoing are not intended to be limiting examples or definitions of “initial integrity”—other milestones in a vehicle component, system, or module's life may also be used to establish a baseline state of degradation or health defining “initial integrity.”

In a number of illustrative variations, a determined state of failure of any vehicle component, system, or module may be correlated to the vehicle's performance as a whole or the performance of particular vehicle components, systems, or modules, and translated into at least one failure state determination. The at least one failure state determination may be monitored by a tertiary control system or module to determine the appropriateness of utilizing the tertiary control system or module as the primary control system or module for at least one vehicle system or module based on the at least one failure state determination. Additionally, at least one failure state determination may be monitored by a tertiary control system or module to determine the risk of inducing the vehicle to perform a minimum-risk maneuver for the purpose of bringing the vehicle to a safe stop.

In a number of illustrative variations, a vehicle may comprise a number of primary steering actuators or primary braking actuators as well as a number of redundant steering actuators or redundant braking actuators, wherein the redundant steering actuators or redundant braking actuators are configured to be manipulated by a tertiary control system upon a failure at least one of the primary steering control system or module, a failure of at least one redundant steering control system or module, or at least one primary steering actuator or primary braking actuator.

In a number of illustrative variations, the systems or components of a vehicle or any combinations thereof may operate according to logic modules by way of software or machine logic. In such cases, any number of modules may be combined together or broken into smaller modules.

In a number of illustrative variations, an autonomous vehicle may be equipped with a planner module. The planner module may refer to a module of software housed in electronically accessible memory housed onboard the vehicle, or accessible via cloud services, or accessible in any other known way in which software may be accessed, or may refer to the planner module software or planner algorithm or the hardware being used to execute the planner module software or algorithm. The planner module software or algorithm may be configured to be executed on a dedicated piece of processing hardware either onboard or remote from the vehicle and communicated to the vehicle.

In a number of illustrative variations, the planner module may plan an autonomous driving vehicle path and trajectory. The planner module may receive or compute a planned destination via computed or received destination coordinates, a computed or received absolute or relative location with regard to the vehicle, or a location within a network of potential destinations, and plan a path for vehicle travel based on known extent roads or vehicle pathways, previous paths taken by the vehicle, paths charted by other vehicles on a network, or by any known means of planning a vehicle path or any combination thereof. In some such illustrations, a vehicle path and trajectory may be computed or received by the autonomous planner module and modified by the planner module based at least upon other data received or collected by the vehicle or other vehicles in a network such as but not limited to local terrain data, road closures data, or traffic data. As a non-limiting example, a vehicle may be travelling autonomously on a received, retrieved, or computed autonomous vehicle path, when the planner module of the vehicle receives data from a network of connected vehicles that indicates that vehicles have been hydroplaning on the road ahead whereas a certain alternative path might pose no such hazard to the vehicle. In Such a case, the vehicle's autonomous planner module may modify the vehicle path with a detour that avoids the road on which frequent hydroplaning has occurred. Similarly, in such illustrative variations, road conditions such as but not limited to road surface friction coefficients, surface quality, visibility conditions such as but not limited to low visibility conditions caused by debris, dust, smoke, reflections, or weather conditions, may be collected, computed, or received by the planner module of the vehicle and may be used in determining if or how to modify the planned vehicle path or trajectory. Additionally, sensors or modules monitoring the vehicle's systems or individual components may communicate a condition or state of health of a vehicle system, component, or module to the planner module or to any of a primary control system or module, redundant control system or module, or tertiary control system or module. In some case, an autonomous vehicle may be equipped with at least one Engine Control Unit (ECU) that may function as a primary control system or module and that may communicate with an Electronic Power Steering (EPS) system. In such a case, any number components such as but not limited to sensors, transistors, switches, relays, amplifiers, or actuators, that communicate with any number of the primary control systems or modules, redundant control systems or modules, or tertiary control systems or modules, may fail or shutdown due to a fault such as but not limited to an underpowering fault in a position sensor, a gate drive fault in a field-effect transistor (FET), a fault due to overheating in an insulated-gate bipolar transistor (IGBT), a fault due to a mechanical or electrical issue with a switch or relay, a fault in an amplified due to underpowering, or a fault in an actuator due to wear and tear, or any other electrical, mechanical, or thermal issue with any similar or associated components. In such cases, an associated primary control system or module, redundant control system or module, or tertiary control system or module may go into a fault mode or fail because one of the components with which it communicates has failed, and this may be communicated to at least one of the primary control system or module, redundant control system or module, or tertiary control system or module, or by any system, module, or controller monitoring any such primary control system or module, redundant control system or module, or tertiary control system or module in the form of a vehicle capability determination via a vehicle capability module so that the planner module may appropriately relinquish control to a redundant control system or module or to a tertiary control system or module. As another non-limiting example, the EPS system itself may fail due to electrical or thermal issues with the EPS circuit components, or from high friction in a mechanical component such as but not limited to a column assist motor. In some such cases, failures affecting the steering of the vehicle may be communicated to the primary control system or module, redundant control system or module, or tertiary control system or module, by any system in which the failure occurs, or in any control system or module monitoring system or module, in the form of a fault signal or vehicle capability determination via at least one vehicle capability module. In some such cases any one of the primary control system or module, redundant control system or module, or tertiary control system or module, or a submodule thereof, or a vehicle capability module, may constantly or periodically poll steering systems to discover such failures or similar or associated failures. When relevant failures resulting in modified vehicle capabilities are presented to the primary control system or module, redundant control system or module or tertiary control system or module may relinquish control of the vehicle systems to at least one other controller in the group comprising the primary control system or module, the redundant control system or module, and the tertiary control system or module based at least upon the failure.

In a number of illustrative variations, failure states and performance capabilities of autonomous vehicle components, systems, or modules may be determined on demand, periodically, or continuously. Failure states and performance capabilities may be based upon the vehicle speed or the state of health or degradation of vehicle components, systems, or modules as well as other things like road surface conditions and tire or wheel conditions. As a non-limiting example, factors like high speed will cause a curvature capability determination to be lower whereas a low speed may allow a curvature capability estimate that follows a simple kinetic bicycle model. As another non-limiting example, a low road surface friction coefficient may cause certain performance capability determinations such as but not limited to steering capability or braking capability determinations to be lower on icy surfaces and higher when the road surface friction coefficient is higher such as on dry concrete. In turn, failure state determinations may be based upon performance capabilities and thus affected by similar factors.

In a number of illustrative variations, the primary control system or module may, in light of the state of health or degradation of vehicle systems, components, or modules, or in light of at least one vehicle capability determination or failure state, autonomously relinquish control of vehicle systems to at least one other control system or module, or receive a request for relinquishment of vehicle systems from at least one other control system or module. In a similar case, when in control of vehicle systems, a redundant control system or module or tertiary control system may autonomously relinquish control of vehicle systems to at least one other control system or module, or receive a request for relinquishment of vehicle systems from at least one other control system or module.

In a number of illustrative variations, a vehicle may be equipped with a primary control system or module that is in communication with vehicle systems, modules, or components. The primary control system or module may collect or receive data on the state of health or degradation of at least one vehicle system, module, or vehicle component. The primary control system or module may track such data for translation into logic for the operation of the autonomous vehicle. This data or operational logic may be communicated to other vehicle components, systems, or modules, or may be accessible to the other vehicle components, systems, modules. In some cases, this operational logic may be duplicated into modules, systems, or components that may be functionally separate from a primary control system or module and that may also be physically separate from such primary control system or module. These functionally or physically separate modules, systems, or components may be referred to as redundant control systems or modules and tertiary control systems and modules herein.

In a number of illustrative variations, any number of vehicle systems or modules may produce a warning regarding such relinquishment or change of control systems or modules that may be communicated to a human occupant of the vehicle, to a central processing module or hub, to the Cloud, or anywhere else that data may be transmitted.

A number of variations may include a product including an autonomous vehicle control system including a first primary motion control system; a redundant motion control system; and, a tertiary motion control system; wherein at least one of the primary control system, the redundant control system, or the tertiary control system may be programmed to self-report its own state of health or degradation, either directly or indirectly, to at least one of the other control systems. In a number of variations, the primary control system, the redundant control system, and the tertiary control system may all programmed to successively manage the control of at least one of the vehicle motion control system functions, the vehicle braking system functions, or the vehicle steering system functions. In a number of variations, the primary control system, the redundant control system, and the tertiary control system may be programmed to successively manage the control of at least one of the vehicle motion control system functions, the vehicle braking system functions, or the vehicle steering system functions based at least upon the self-reported state of health or degradation of at least one of the other control systems. In a number of variations, the control systems may be programmed to successively manage the control of at least one of the vehicle motion control system functions, the vehicle braking system functions, or the vehicle steering system functions in sequence: first, primary control system controls at least one vehicle function; then, based upon a self-reported state of health or degradation by the primary control system that pertains to the primary control systems ability control of the at least one vehicle function, the redundant control system assumes control of the at least one vehicle function; then, based upon both the self-reported state of health or degradation by the primary control system that pertains to the primary control system's ability to control of the at least one vehicle function, as well as a self-reported state of health or degradation by the redundant control system that pertains also to the redundant control system's ability to control the at least one vehicle function, the tertiary control system assumes control of the at least one vehicle function. In a number of variations, the tertiary control system only succeeds the primary control system and redundant control system for control of at least one vehicle function in response to both the primary control system and redundant control system self-reporting themselves being in a state of health or degradation that is unacceptable for control of the at least one vehicle function.

A number of variations may include a product including an autonomous vehicle control system including a primary control system; a redundant control system; and, a tertiary control system; wherein the primary control system may be programmed to control at least one vehicle function via at least one primary vehicle component that is suited to perform the vehicle function, and wherein at least one of the redundant control system or the tertiary control system is programmed to monitor the sufficiency of the state of health of the primary control system for controlling the at least one primary vehicle component. In a number of variations, the tertiary control system may be further programmed to monitor the sufficiency of the state of health of the redundant control system for controlling the at least one primary vehicle component. In a number of variations, the primary control system may be further programmed to monitor the sufficiency of the state of health of the at least one primary vehicle component for performing the vehicle function. In a number of variations, the tertiary control system is further programmed to assume control of the vehicle function if it determines that both the primary control system and the redundant control system are in an insufficient state of health or degradation for controlling the at least one primary vehicle component. In a number of variations, the tertiary control system may be further programmed to assume control of the vehicle function via at least one redundant vehicle component if it determines that the at least one primary vehicle component is in an insufficient state of health for performing the vehicle function. In a number of variations, the tertiary control system is further programmed to perform a minimum risk maneuver to bring a vehicle to a safe stop based upon the insufficiency of the state of health of the at least one primary vehicle component for performing the vehicle function as well as the insufficiency of the state of health of the tertiary system for controlling the at least one redundant vehicle component. In a number of variations, the tertiary control system is further programmed to perform a minimum risk maneuver to bring a vehicle to a safe stop based upon at least one of the insufficiency of the state of health of the at least one primary vehicle component for performing the vehicle function as well as the insufficiency of the state of health of the at least one redundant vehicle component for performing the vehicle function.

A number of variations may include a product including an autonomous vehicle control system including at least one primary vehicle component for performing a vehicle braking function, steering function, or motion control function; and, at least one redundant vehicle component for performing the vehicle braking function, steering function, or motion control function; wherein the at least one redundant vehicle component is constructed and arranged to be used for performing the vehicle braking function, steering function, or motion control function when the at least one primary vehicle component is determined to be in an insufficient state of health for performing the vehicle braking function, steering function, or motion control function. In a number of variations, the product may further include a tertiary controller that is constructed and arranged to control the at least one redundant vehicle component for the purpose of performing the vehicle braking function, steering function, or motion control function. In a number of variations, the tertiary controller is programmed to control the at least one redundant vehicle component if the at least one primary vehicle component ceases to perform the vehicle braking function, steering function, or motion control function.

Referring to FIGS. 5A, 5B and 5C, in a number of variations a tertiary control systems 500 may include a plurality of control modules which may include, but is not limited to, a tertiary motion control 502 which may include module 504 to facilitate a tertiary motion control functions. A tertiary steering control module 503 may provide tertiary steering functions 505. A tertiary braking control module 504 may provide tertiary braking functions 505. A steering request 512 may be communicated by the tertiary motion control module 502 to the tertiary steering control module 503, and a braking request 514 may be communicated to the tertiary braking control module 504.

A tertiary steering actuator 506 may be provided in the tertiary control system 500 and may provide for applying steering motor torque functionality 527 and may provide functionality for sensing steering actuator position 529. A steering motor torque signal 515 may be provided by the tertiary steering control 503, and the tertiary steering actuator may provide a right tie rod force 524 and a left eye rod force 526. The tertiary control system 500 may include a left wheel brake actuator 508 which may provide applied brake torque functionality 531 and may provide functionality to sense left wheel speed 533. The tertiary brake control module 504 may provide left wheel brake torque request 518 to the left wheel brake actuator 508 and the left wheel brake actuator 508 may apply left brake torque 528 or left wheel speed adjustment 530. The tertiary control system 500 may include a right wheel brake actuator 510 and provide applied brake motor torque 538 and functionality to sense left wheel speed 537. The tertiary brake control module 504 may provide a right wheel brake torque request 520 to the right wheel brake actuator 510 resulting in a right brake torque 532 and a right wheel speed adjustment 534. In a number of variations, tertiary motion control may be accomplished with a module including the co-location of electronics to sense and control both tertiary steering and braking actuators. The tertiary motion, steering, and braking software plus hardware electronics may be integrated in a physical module.

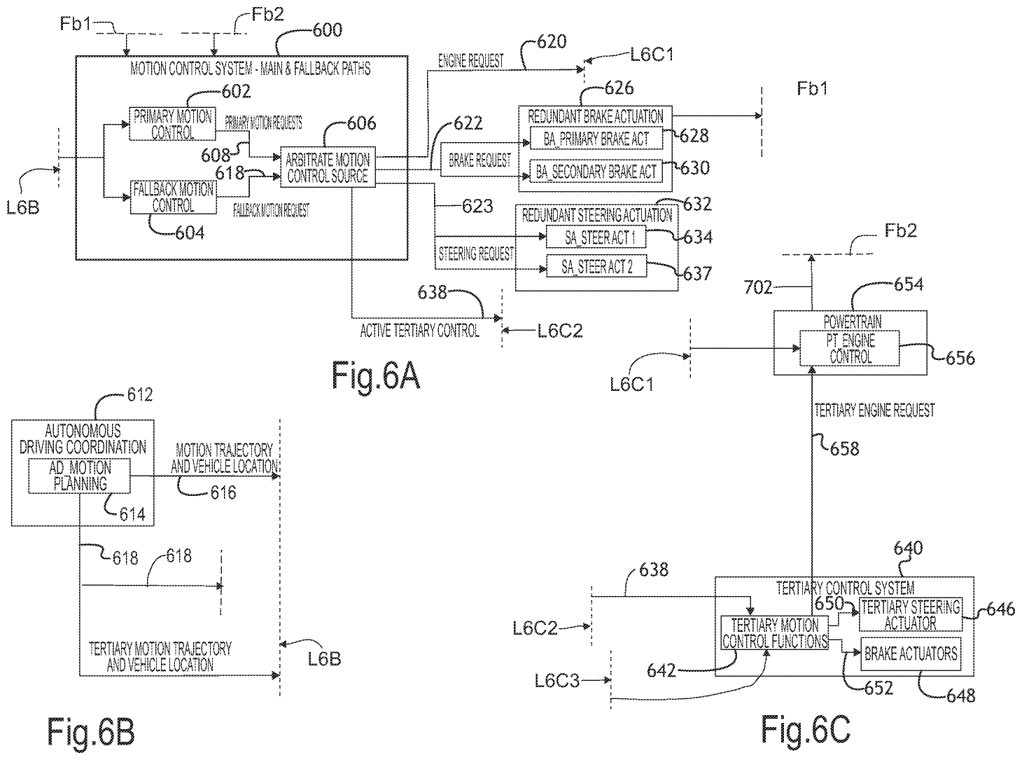

Referring now to FIG. 5B, in a number of variations, a plurality of vehicle components and systems may be communicatively connected to the tertiary control system 500. For example, the vehicle battery and ignitor 636 may be communicatively connected to supply battery voltage and vehicle ignition information to the tertiary control system 500. An autonomous driving condition module 642 including minimum risk maneuver (MRM) planning 644 and EGO motion localization 646 may be communicatively connected to the tertiary control system 502 to provide motion trajectory information 648, pose and position information 650, autonomous driving (AD) system status information 652, and tertiary control system status 654. A primary/redundant control system 656 may be communicatively connected to the tertiary control system 500 to provide motion control system status information 656. A vehicle data exchange system 660 including brake lamp 652, vehicle dynamic signal 664, steering wheel angle 666, and perform standstill management request 668 may be communicatively connected to provide vehicle information 658 to the tertiary control system 500. The tertiary control system 500 (FIG. 6A) may use parking brake actuator technology to support a redundant parking brake capability for the case where primary parking brakes are lost due to primary/redundant brake system failures. An autonomous vehicle will be prevented from unsafely rolling after the MRM is performed by the tertiary control system 500 supporting the standstill management request 668 from the vehicle.

Referring now to FIG. 5C, in a number of variations a plurality of vehicle components and systems may be communicatively connected to the tertiary control system 504 control of the same and may provide feedback therefrom. The plurality of vehicle components and systems including, for example but not limited to, a propulsion system 572, front left wheel assembly 574, front right wheel is similarly 576, rear left wheel assembly 578, and rear right wheel assembly 580.

Referring now to FIGS. 6A, 6B and 6C, in a number of variations a system may include a motion control system-main and fallback paths 600 which may include a primary control module 602 and a fallback control module 604. The primary control module 602 may communicate primary motion requests 608 to an arbitrative motion control source module 606. Likewise, the fallback motion control module 604 may communicate fallback motion requests 618 to the arbitrate motion control source module 608. The arbitrary motion control source module 608 may determine which control system should be utilized to control various vehicle components based upon the failure or insufficient health of the primary motion control module 602 and/or the fallback motion control module 604. If the primary control module 602 has failed or has insufficient health status then the arbitrative motion control source module 606 will switch control to the backup control module 604. If the fallback control module 604 also fails or has insufficient health status the arbitrate motion control source module 606 will switch control to activate the tertiary control 638 of the tertiary control system 640 which is the same tertiary control system 500 shown in FIG. 5A. The arbitrate motion control source module 606 may make an engine request 622 to a powertrain system 654 which may include a power train engine control module 656. The arbitrate motion control source module 606 may make a brake request to the redundant brake actuation system 626 for the primary brake actuation 628 or the redundant brake actuation 630 depend upon which control module has been activated. The arbitrate motion control source module 606 may send a steering request to a redundant steering actuation module 632 for a first steering actuator 634 or second steering actuation 637 depending upon whether the primary motion control module 602 or the fallback motion control module 604 has been activated or in control. The autonomous driving coordination system 612 may provide the tertiary motion trajectory and Vehicle Location 618 (from FIG. 6B) to tertiary motion control functions (642). A diagnostic feedback data path 700 from the brake actuation system 626, and a diagnostic feedback data path 702 from powertrain system 654 may be provide to both the motion control system 600 and the tertiary control system 640.

As schematically illustrated in FIG. 6B, in a number of variations an autonomous driving coordination system 612 which may include an autonomous driving motion planner module 614 may be communicatively connected to the motion control system-main and fallback paths system 600 to provide trajectory and vehicle location 616 and tertiary motion trajectory and vehicle location 618.

Referring to FIG. 6C, in a number of variations the tertiary control system 640 may include a tertiary control functions module 642 communicatively connected 650 to the tertiary steering actuator 646 and communicatively connected 652 to the brake actuator 648. The tertiary control system 64 as illustrated in FIG. 6C operates as described regarding the tertiary control system 500 shown in FIG. 5A.

The control systems and subsystem as described herein may further include one or more controllers (not shown) in communication with the actuators and sensors for receiving and processing sensor input and transmitting actuator output signals and output signals to systems or subsystems. The controller(s) may include one or more suitable processors and memory devices (not shown). The memory may be configured to provide storage of data and instructions that provides at least some of the functionality of the system and/or subsystems that may be executed by the processor(s). At least portions of the method may be enabled by one or more computer programs and various engine system data or instructions stored in memory as look-up tables, maps, models, or the like. In any case, the control system and subsystem controls vehicle system parameters by receiving input signals from the sensors, executing instructions or algorithms in light of sensor input signals, and transmitting suitable output signals to the various actuators and output signals to systems or subsystems. The control system and subsystem may include several modules in the controller(s). As used herein, the term “model” includes any construct that represents something using variables, such as a look up table, map, algorithms and/or the like. Models are application specific and particular to the exact design and performance specifications of any given system. Modules may include sensors, controllers, actuators or other modules or control modules. The following description of variants is only illustrative of components, elements, acts, products and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product including: an autonomous vehicle control system including: a first primary motion control system; a redundant motion control system; and, a tertiary motion control system; wherein at least one of the primary control system, the redundant control system, or the tertiary control system is programmed to self-report its own state of health or degradation, either directly or indirectly, to at least one of the other control systems.

Variation 2 may include the product of variation 1 wherein the primary control system, the redundant control system, and the tertiary control system are all programmed to successively manage the control of at least one of the vehicle motion control system functions, the vehicle braking system functions, or the vehicle steering system functions.

Variation 3 may include the product of any of variations 1-2 wherein the primary control system, the redundant control system, and the tertiary control system are programmed to successively manage the control of at least one of the vehicle motion control system functions, the vehicle braking system functions, or the vehicle steering system functions based at least upon the self-reported state of health or degradation of at least one of the other control systems.

Variation 4 may include the product of any of variations 1-3 wherein the control systems are programmed to successively manage the control of at least one of the vehicle motion control system functions, the vehicle braking system functions, or the vehicle steering system functions in sequence: first, primary control system controls at least one vehicle function; then, based upon a self-reported state of health or degradation by the primary control system that pertains to the primary control systems ability control of the at least one vehicle function, the redundant control system assumes control of the at least one vehicle function; then, based upon both the self-reported state of health or degradation by the primary control system that pertains to the primary control system's ability to control of the at least one vehicle function, as well as a self-reported state of health or degradation by the redundant control system that pertains also to the redundant control system's ability to control the at least one vehicle function, the tertiary control system assumes control of the at least one vehicle function.

Variation 5 may include the product of any of variations 1-4 wherein the tertiary control system only succeeds the primary control system and redundant control system for control of at least one vehicle function in response to both the primary control system and redundant control system self-reporting themselves being in a state of health or degradation that is unacceptable for control of the at least one vehicle function.

Variation 6 may include a product including: an autonomous vehicle control system including: a primary control system; a redundant control system; and, a tertiary control system; wherein the primary control system is programmed to control at least one vehicle function via at least one primary vehicle component that is suited to perform the vehicle function, and wherein at least one of the redundant control system or the tertiary control system is programmed to monitor the sufficiency of the state of health of the primary control system for controlling the at least one primary vehicle component.

Variation 7 may include the product of variation 6 wherein the tertiary control system is further programmed to monitor the sufficiency of the state of health of the redundant control system for controlling the at least one primary vehicle component.

Variation 8 may include the product of any of variations 6-7 wherein the primary control system is further programmed to monitor the sufficiency of the state of health of the at least one primary vehicle component for performing the vehicle function.

Variation 9 may include the product of any of variations 6-8 where the tertiary control system is further programmed to assume control of the vehicle function if it determines that both the primary control system and the redundant control system are in an insufficient state of health or degradation for controlling the at least one primary vehicle component.

Variation 10 may include the product of any of variations 6-9 where the tertiary control system is further programmed to assume control of the vehicle function via at least one redundant vehicle component if it determines that the at least one primary vehicle component is in an insufficient state of health for performing the vehicle function.

Variation 11 may include the product of any of variations 6-10 wherein the tertiary control system is further programmed to perform a minimum risk maneuver to bring a vehicle to a safe stop based upon the insufficiency of the state of health of the at least one primary vehicle component for performing the vehicle function as well as the insufficiency of the state of health of the redundant system for controlling the at least one redundant vehicle component.

Variation 12 may include the product of any of variations 6-11 wherein the tertiary control system is further programmed to perform a minimum risk maneuver to bring a vehicle to a safe stop based upon at least one of the insufficiency of the state of health of the at least one primary vehicle component for performing the vehicle function as well as the insufficiency of the state of health of the at least one redundant vehicle component for performing the vehicle function.

Variation 13 may include a product including: a redundant vehicle control system for an autonomous vehicle including: at least one primary vehicle component for performing a vehicle braking function, steering function, or motion control function; and, at least one redundant vehicle component for performing the vehicle braking function, steering function, or motion control function; wherein the at least one redundant vehicle component is constructed and arranged to be used for performing the vehicle braking function, steering function, or motion control function when the at least one primary vehicle component is determined to be in an insufficient state of health for performing the vehicle braking function, steering function, or motion control function.

Variation 14 may include a product of variation 13 further including a tertiary controller that is constructed and arranged to control the at least one redundant vehicle component for the purpose of performing the vehicle braking function, steering function, or motion control function.

Variation 15 may include a product comprising: A vehicle motion controller constructed and arranged to monitor an autonomous vehicle steering, braking, or drive system, wherein the autonomous vehicle steering, braking, or drive system comprises at least one steering, braking, or drive component and the vehicle motion controller is configured to determine at least one steering, braking, or drive system capability over a period of operation of the autonomous vehicle steering, braking, or drive system by monitoring at least the state of health or degradation of the at least one steering, braking or drive component via onboard vehicle sensors, and wherein the vehicle motion controller is configured to communicate the determined steering, braking, or drive system capability of the at least one steering, braking, or drive component to at least one other vehicle system.

Variation 16 may include any of the products of claims 17, 18, or 19, wherein the vehicle motion controller is not onboard a vehicle.

Variation 17 may include any of the products of claim 15, 16, 18, or 19 wherein the period of operation of the autonomous vehicle steering, braking, or drive system is a period encompassing numerous intermittent driving sessions during each of which a vehicle using the autonomous vehicle steering, braking, or drive system is started, driven, and then shut down.

Variation 18 may include any of the products of claim 15, 16, 17, or 19, further comprising a planner module configured to receive and interpret the communicated determined steering, braking, or drive system capability from the vehicle motion controller and to determine an autonomous vehicle path based at least upon the communicated determined steering, braking, or drive system capability.

Variation 19 may include any of the products of claim 15, 16, 17, or 18, wherein the planner module is not onboard a vehicle.

Variation 20 may include a product comprising a module integrating and co-locating electronics to sense and control both tertiary steering and braking actuators for an autonomous vehicle.

Variation 21 may include a product as set forth in variation 20 further comprising a redundant vehicle control system for an autonomous vehicle comprising:

at least one primary vehicle component for performing a vehicle braking function, steering function, or motion control function; and,

at least one redundant vehicle component for performing the vehicle braking function, steering function, or motion control function;

wherein the at least one redundant vehicle component is constructed and arranged to be used for performing the vehicle braking function, steering function, or motion control function when the at least one primary vehicle component is determined to be in an insufficient state of health for performing the vehicle braking function, steering function, or motion control function.

Variation 22 product comprising: a tertiary control system for a vehicle comprising parking brake actuator system to support a redundant parking brake capability if primary parking brakes of the vehicle are lost due to primary/redundant brake system failures.

Variation 23 may include a product of variation 21 wherein the parking brake actuator system is constructed and arranged to prevent an unsafely rolling of the vehicle after a minimum risk maneuver is performed by the tertiary control system supporting a standstill management request from the vehicle.

Variation 24 may include a tertiary controller for use in an autonomous vehicle having a primary controller, a redundant controller and the tertiary controller, wherein the primary controller, the redundant controller and the tertiary controller controls at least one of a steering, a braking, or a drive system of the autonomous vehicle, the tertiary controller figured to have at least one of the following operational modes:

an active mode actively controlling braking and steering—wherein the tertiary controller is active when there is a complete dual point failure in a either redundant steering system or a redundant brake system:

a monitoring mode wherein the tertiary controller is not controlling steering or braking when there is a no failure in either redundant steering system or redundant brake system, and wherein the tertiary controller sends a health status signal to an autonomous driving condition module repeatedly;

a standby mode when there is a single point failure in either a redundant steering system or a redundant brake system and the tertiary controller is not controlling steering or braking of the autonomous vehicle, and wherein the tertiary sends a health status signal to an autonomous driving condition module repeatedly;

a disabled mode when there is a failure in the tertiary controller.

Variation 25 may include a tertiary controller as set forth in claim 24 wherein the tertiary controller is configured to have each of the active mode, monitoring mode, standby mode, and disabled mode. The above description of select variations within the scope of the invention is merely illustrative in nature and, thus, variations or variants thereof are not to be regarded as a departure from the spirit and scope of the invention.

What is claimed is:

1. A product comprising:
an autonomous vehicle control system comprising:
a primary control system;
a redundant control system; and,
a tertiary control system;
wherein at least one of the primary control system, the redundant control system, or the tertiary control system is programmed to self-report its own state of health or degradation, either directly or indirectly, to at least one of the other control systems.

2. The product of claim 1 wherein the primary control system, the redundant control system, and the tertiary control system are all programmed to successively manage the control of at least one of the vehicle motion control system functions, the vehicle braking system functions, or the vehicle steering system functions.

3. The product of claim 2 wherein the primary control system, the redundant control system, and the tertiary control system are programmed to successively manage the control of at least one of the vehicle motion control system functions, the vehicle braking system functions, or the vehicle steering system functions based at least upon the self-reported state of health or degradation of at least one of the other control systems.

4. The product of claim 3 wherein the control systems are programmed to successively manage the control of at least one of the vehicle motion control system functions, the vehicle braking system functions, or the vehicle steering system functions in sequence:
first, primary control system controls at least one vehicle function;
then, based upon a self-reported state of health or degradation by the primary control system that pertains to the primary control systems ability control of the at least one vehicle function, the redundant control system assumes control of the at least one vehicle function;
then, based upon both the self-reported state of health or degradation by the primary control system that pertains to the primary control system's ability to control of the at least one vehicle function, as well as a self-reported state of health or degradation by the redundant control system that pertains also to the redundant control system's ability to control the at least one vehicle function, the tertiary control system assumes control of the at least one vehicle function.

5. The product of claim 3 wherein the tertiary control system only succeeds the primary control system and redundant control system for control of at least one vehicle function in response to both the primary control system and redundant control system self-reporting themselves being in a state of health or degradation that is unacceptable for control of the at least one vehicle function.

6. A product comprising:
an autonomous vehicle control system comprising:
a primary control system;
a redundant control system; and,
a tertiary control system;
wherein the primary control system is programmed to control at least one vehicle function via at least one primary vehicle component that is suited to perform the vehicle function, and wherein at least one of the redundant control system or the tertiary control system is programmed to monitor the sufficiency of the state of health of the primary control system for controlling the at least one primary vehicle component.

7. The product of claim 6 wherein the tertiary control system is further programmed to monitor the sufficiency of the state of health of the redundant control system for controlling the at least one primary vehicle component.

8. The product of claim 6 wherein the primary control system is further programmed to monitor the sufficiency of the state of health of the at least one primary vehicle component for performing the vehicle function.

9. The product of claim 7 where the tertiary control system is further programmed to assume control of the vehicle function if it determines that both the primary control system and the redundant control system are in an insufficient state of health or degradation for controlling the at least one primary vehicle component.

10. The product of claim 8 where the tertiary control system is further programmed to assume control of the vehicle function via at least one redundant vehicle component if it determines that the at least one primary vehicle component is in an insufficient state of health for performing the vehicle function.

11. The product of claim 10 wherein the tertiary control system is further programmed to perform a minimum risk maneuver to bring a vehicle to a safe stop based upon the insufficiency of the state of health of the at least one primary vehicle component for performing the vehicle function as well as the insufficiency of the state of health of the tertiary system for controlling the at least one redundant vehicle component.

12. The product of claim 10 wherein the tertiary control system is further programmed to perform a minimum risk maneuver to bring a vehicle to a safe stop based upon at least one of the insufficiency of the state of health of the at least one primary vehicle component for performing the vehicle function as well as the insufficiency of the state of health of the at least one redundant vehicle component for performing the vehicle function.

13. A product comprising:
a redundant vehicle control system for an autonomous vehicle comprising:
at least one primary vehicle component for performing a vehicle braking function, steering function, or motion control function; and,
at least one redundant vehicle component for performing the vehicle braking function, steering function, or motion control function;
wherein the at least one redundant vehicle component is constructed and arranged to be used for performing the vehicle braking function, steering function, or motion control function when the at least one primary vehicle component is determined to be in an insufficient state of health for performing the vehicle braking function, steering function, or motion control function.

14. The product of claim 13 further comprising a tertiary controller that is constructed and arranged to control the at least one redundant vehicle component for the purpose of performing the vehicle braking function, steering function, or motion control function.

15. A product comprising:
a vehicle motion controller constructed and arranged to monitor an autonomous vehicle steering, braking, or drive system, wherein the autonomous vehicle steering, braking, or drive system comprises at least one steering, braking, or drive component and the vehicle motion controller is configured to determine at least one steering, braking, or drive system capability over a period of operation of the autonomous vehicle steering, braking, or drive system by monitoring at least the state of health or degradation of the at least one steering, braking or drive component via onboard vehicle sensors, and wherein the vehicle motion controller is configured to communicate the determined steering, braking, or drive system capability of the at least one steering, braking, or drive component to at least one other vehicle system.

16. The product of claim 15 wherein the vehicle motion controller is not onboard a vehicle.

17. The product of claim 15 wherein the period of operation of the autonomous vehicle steering, braking, or drive system is a period encompassing numerous intermittent driving sessions during each of which a vehicle using the autonomous vehicle steering, braking, or drive system is started, driven, and then shut down.

18. A product comprising a module integrating and co-locating electronics to sense and control both tertiary steering and braking actuators for an autonomous vehicle.

19. A product comprising: a tertiary control system for a vehicle comprising parking brake actuator system to support a redundant parking brake capability if primary parking brakes of the vehicle are lost due to primary/redundant brake system failures.

20. A tertiary controller for use in an autonomous vehicle having a primary controller, a redundant controller and the tertiary controller, wherein the primary controller, the redundant controller and the tertiary controller controls at least one of a steering, a braking, or a drive system of the autonomous vehicle, the tertiary controller figured to have at least one of the following operational modes:
(a) an active mode actively controlling braking and steering-wherein the tertiary controller is active when there is a complete dual point failure in a either redundant steering system or a redundant brake system:
(b) a monitoring mode wherein the tertiary controller is not controlling steering or braking when there is a no failure in either redundant steering system or redundant brake system, and
wherein the tertiary controller sends a health status signal to an autonomous driving condition module repeatedly.
(c) a standby mode when there is a single point failure in either a redundant steering system or a redundant brake system and the tertiary controller is not controlling steering or braking of the autonomous vehicle, and wherein the tertiary sends a health status signal to an autonomous driving condition module repeatedly;
(d) a disabled mode when there is a failure in the tertiary controller.
